(19) United States
(12) Patent Application Publication
(10) Pub. No.: US 2013/0068746 A1
(43) Pub. Date: Mar. 21, 2013

(54) SOLDERING METHOD AND SOLDERING APPARATUS

(71) Applicant: Hiroshi ITO, Kanagawa-ken (JP)

(72) Inventor: Hiroshi ITO, Kanagawa-ken (JP)

(73) Assignee: Kabushiki Kaisha Toshiba, Tokyo (JP)

(21) Appl. No.: 13/616,604

(22) Filed: Sep. 14, 2012

(30) Foreign Application Priority Data
Sep. 16, 2011 (JP) 2011-203212

(51) Int. Cl. B23K 11/00

(52) U.S. Cl. 219/148

(57) ABSTRACT

According to one embodiment, a soldering method includes preparing a lower substrate supporting a plurality of first connection terminals, and an upper substrate with a plurality of second connection terminals; opposing the plurality of first connection terminals and the plurality of second connection terminals respectively across a solder material; partitioning a placement region disposed with the plurality of second connection terminals in the upper substrate into rectangular regions, each of the rectangular regions being larger than area occupied by each of the plurality of second connection terminals; irradiating each of the rectangular regions sequentially with light from a side of the upper substrate to melt the solder material by increasing temperature of the lower substrate, and the light capable of being transmitted through the upper substrate; bonding the plurality of first connection terminals and the plurality of second connection terminals respectively with the solder material.

### CROSS-REFERENCE TO RELATED APPLICATIONS

This application is based upon and claims the benefit of priority from Japanese Patent Application No. 2011-203212, filed on Sep. 16, 2011; the entire contents of which are incorporated herein by reference.

### FIELD

Embodiments described herein relate generally to a soldering method and a soldering apparatus.

### BACKGROUND

As a soldering technique for bonding connection terminals together, the pulse heating method is known. However, the pulse heating method is of the contact type, and hence requires countermeasures against electrostatic discharge (ESD). Furthermore, in the pulse heating method, a pressure is applied to the connection terminals. This requires backup measures on the substrate side. Thus, instead of contact type soldering techniques, non-contact type soldering techniques have received attention.

As a typical example of non-contact type soldering techniques, the soldering method by light irradiation is known. This method can be based on e.g. lamp heating or laser light irradiation. In the method based on laser light irradiation, all the connection terminals may be collectively irradiated with laser light. Alternatively, the connection terminals may be separately irradiated with laser light scanned in a prescribed direction.

### BRIEF DESCRIPTION OF THE DRAWINGS

FIG. 1 describes a flow of a soldering method according to a first embodiment;

FIG. 2A is a three-dimensional schematic view for describing the overall structure of the hard disk;

FIG. 2B is a three-dimensional schematic view for describing the structure of a head section;

FIG. 3A is a schematic plan view of the front side of the relay FPC;

FIG. 3B is a schematic plan view of the rear side of the relay FPC;

FIG. 4A is a schematic plan view of the front side of the main FPC;

FIG. 4B is a schematic plan view of the rear side of the main FPC;

FIGS. 5A to 5C are schematic views describing the state in which the copper wirings of the relay FPC and the copper wirings of the main FPC are opposed to each other;

FIG. 6 is a view for describing a method for partitioning the region disposed with the plurality of second connection terminals into a plurality of rectangular regions;

FIG. 7A describes the sequence of irradiating the plurality of rectangular regions with laser light;

FIG. 7B is an enlarged view corresponding to the enclosed portion indicated by the arrow A of FIG. 5A;

FIG. 7C is a sectional view corresponding to the X-Y cross section of FIG. 5A;

FIG. 8A is a view for describing a method for partitioning the region disposed with the plurality of second connection terminals into a plurality of rectangular regions according to a second embodiment;

FIG. 8B describes the sequence of irradiating the plurality of rectangular regions with laser light according to the second embodiment;

FIGS. 9A and 9B describe the sequence of soldering according to a third embodiment;

FIG. 10 describes the sequence of soldering according to a fourth embodiment;

FIG. 11 describes a soldering apparatus according to a fifth embodiment; and

FIG. 12 describes a variation of the soldering apparatus according to the fifth embodiment.

### DETAILED DESCRIPTION

In general, according to one embodiment, a soldering method includes preparing a lower substrate supporting a plurality of first connection terminals with a solder material provided on an upper surface of each of the plurality of first connection terminals, and an upper substrate with a plurality of second connection terminals corresponding to respective positions of the plurality of first connection terminals, and the plurality of second connection terminals disposed on the upper substrate. The method includes opposing the plurality of first connection terminals and the plurality of second connection terminals respectively to each other across the solder material. The method includes partitioning a placement region disposed with the plurality of second connection terminals in the upper substrate into rectangular regions, each of the rectangular regions being larger than area occupied by each of the plurality of second connection terminals. The method includes irradiating each of the rectangular regions sequentially with light from a side of the upper substrate to melt the solder material provided on the lower substrate by increasing temperature of the lower substrate, and the light capable of being transmitted through the upper substrate. And the method includes bonding the plurality of first connection terminals and the plurality of second connection terminals respectively with the solder material.

Embodiments will now be described with reference to the drawings. In the following description, like members are labeled with like reference numerals. The description of the members once described is omitted appropriately.

### First Embodiment

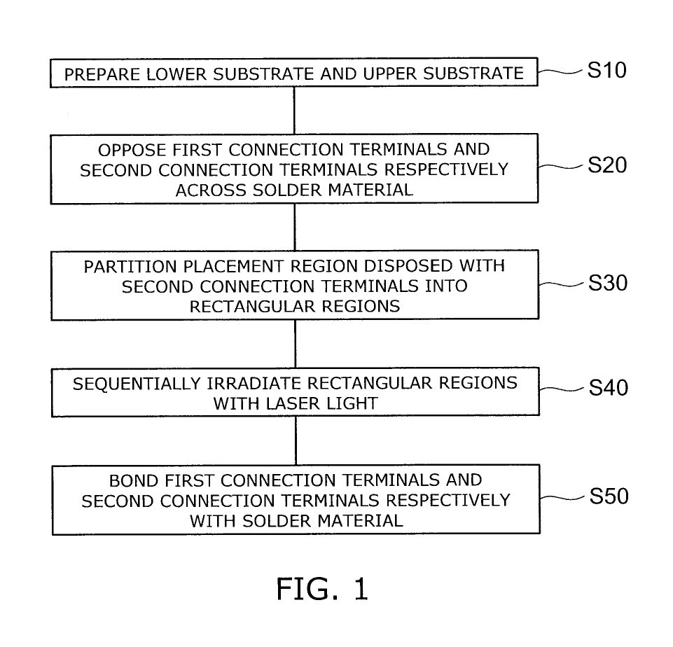

FIG. 1 describes a flow of a soldering method according to a first embodiment.

First, in the first embodiment, a lower substrate (i.e. an under side substrate) and an upper substrate (i.e. an upper side substrate) are prepared (step S10). The lower substrate supports a plurality of first connection terminals. A solder material is provided on the upper surface of each of the plurality of first connection terminals. On the upper substrate, a plurality of second connection terminals are disposed so as to correspond to the respective positions of the plurality of first connection terminals.

Next, the plurality of first connection terminals and the plurality of second connection terminals are respectively opposed to each other across the solder material (step S20).

Next, the placement region disposed with the plurality of second connection terminals in the upper substrate is partitioned into rectangular regions (step S30). The rectangular region is larger than the area occupied by each of the plurality of second connection terminals.

Next, a plurality of rectangular regions including more than one rectangular region are sequentially irradiated with laser light from a side of the upper substrate. The laser light can be transmitted through the upper substrate. Thus, the temperature of the lower substrate is increased. Hence, heat is conducted from the lower substrate to the solder material. Thus, the solder material is melted (step S40).

Next, the plurality of first connection terminals and the plurality of second connection terminals are respectively bonded with the solder material (step S50).

By this flow, the plurality of first connection terminals disposed on the lower substrate and the plurality of second connection terminals disposed on the upper substrate are respectively bonded with the solder material. In step S30, the placement region disposed with the plurality of second connection terminals in the upper substrate is partitioned into rectangular regions. The rectangular region is larger than the area occupied by each of the plurality of second connection terminals. This step may be performed before step S20. In this case, the steps labeled with “S30” and “S20” shown in FIG. 1 are interchanged.

A specific method of the soldering method of the first embodiment is now described.

In the first embodiment, the above soldering method is applied to e.g. soldering connection terminals in a hard disk (HDD). The capacity increase of hard disks (HDD) has led to the increase in the number of connection terminals and the miniaturization of connection terminals. In this situation, the above soldering method is useful.

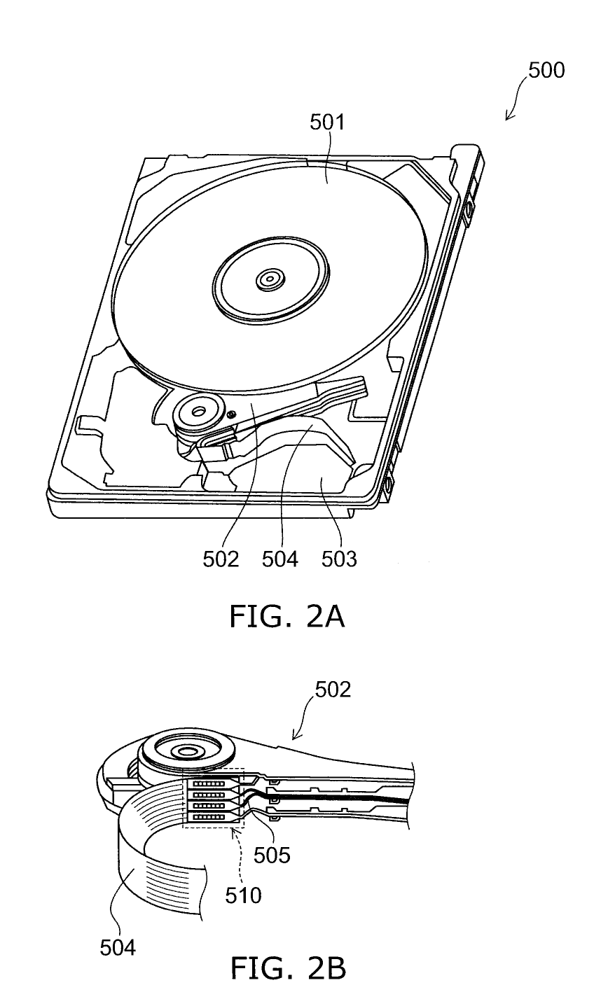

FIGS. 2A and 2B are views for generally describing a hard disk. FIG. 2A is a three-dimensional schematic view for describing the overall structure of the hard disk. FIG. 2B is a three-dimensional schematic view for describing the structure of a head section.

As shown in FIG. 2A, the hard disk 500 includes a disk-shaped magnetic recording medium 501. Furthermore, the hard disk 500 includes a head section (head stack assembly) 502 for writing data on the magnetic recording medium 501 and reading data from the magnetic recording medium 501. The head section 502 and a board body 503 are connected via a main flexible printed circuit board 504 (hereinafter, main FPC 504). The head section 502 and the main FPC 504 are connected via a relay flexible printed circuit board 505 (hereinafter, relay FPC 505) extended from the head section 502.

In the first embodiment, the connection terminals provided on the relay FPC 505 in the portion indicated by the arrow 510 and the connection terminals provided on the main FPC 504 in the portion indicated by the arrow 510 are bonded by the above soldering method.

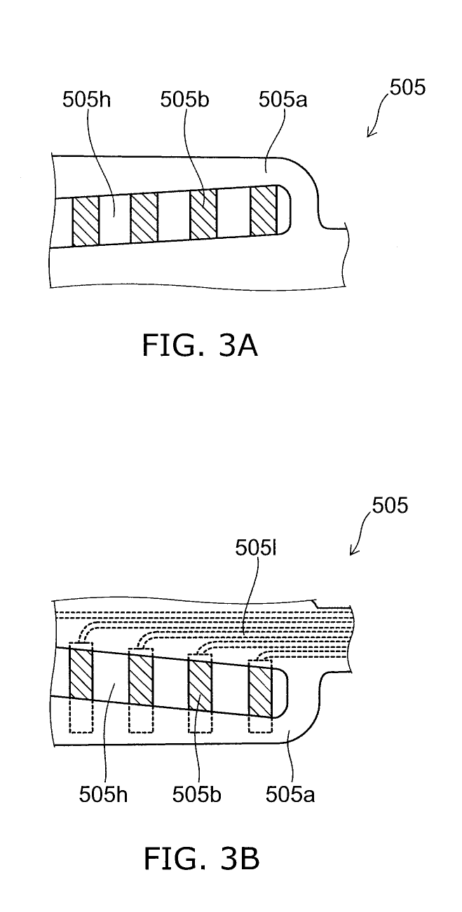

FIGS. 3A and 3B are schematic plan views showing the structure of the relay FPC. FIG. 3A is a schematic plan view of the front side of the relay FPC. FIG. 3B is a schematic plan view of the rear side of the relay FPC. FIGS. 3A and 3B show the relay FPC 505 in the portion indicated by the arrow 510.

The relay FPC 505 includes an insulating film substrate 505a which is the upper substrate. The material of the insulating film substrate 505a is e.g. polyimide resin. The insulating film substrate 505a has a hole 505h. The relay FPC 505 includes a plurality of copper wirings 505b which are the second connection terminals. The copper wiring 505b is also called a flying lead. The plurality of copper wirings 505b are periodically arranged in a row. Each of the plurality of copper wirings 505b is connected to a wiring 505l provided in the insulating film substrate 505a. Each of the plurality of copper wirings 505b is disposed so as to traverse the hole 505h. Part of each of the plurality of copper wirings 505b is exposed in the hole 505h. The surface of the copper wirings 505b may be plated with e.g. gold (Au) or nickel (Ni) to improve the wettability of the solder material in solder bonding.

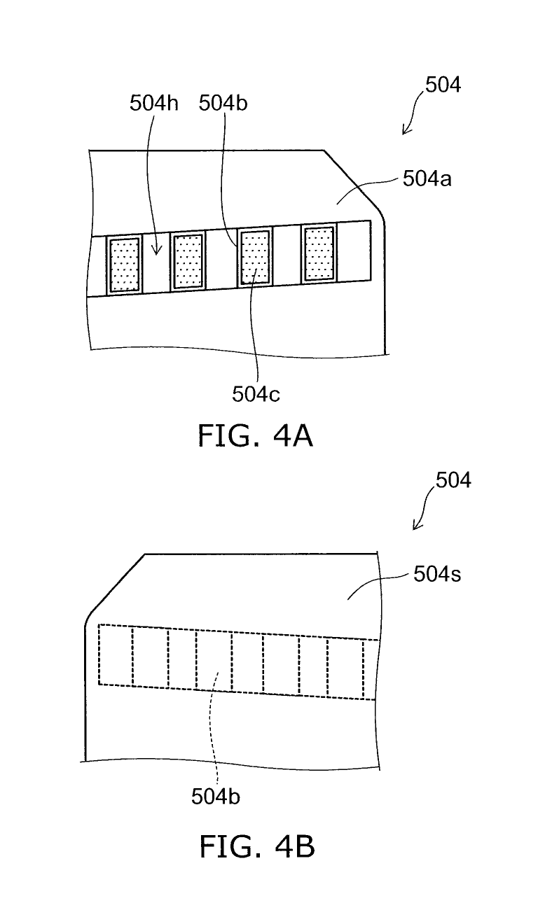

FIGS. 4A and 4B are schematic plan views showing the structure of the main FPC. FIG. 4A is a schematic plan view of the front side of the main FPC. FIG. 4B is a schematic plan view of the rear side of the main FPC. FIGS. 4A and 4B show the main FPC 504 in the portion indicated by the arrow 510.

The main FPC 504 includes a base substrate 504s which is the lower substrate. This base substrate 504s is fixed to the aforementioned head section 502. The material of the base substrate 504s is e.g. stainless steel (SUS) or aluminum (Al). The base substrate 504s is exposed at a side of the rear surface of the main FPC 504. The main FPC 504 includes an insulating film substrate 504a. The insulating film substrate 504a is exposed at a side of the front surface of the main FPC 504. The material of the insulating film substrate 504a is e.g. polyimide resin. The base substrate 504s and the insulating film substrate 504a are bonded with an adhesive.

The insulating film substrate 504a has a hole 504h. The main FPC 504 includes a plurality of copper wirings 504b which are the first connection terminals. The plurality of copper wirings 504b are periodically arranged in a row. Each of the plurality of copper wirings 504b is disposed so as to traverse the hole 504h. That is, part of the upper surface of each of the plurality of copper wirings 504b is exposed in the hole 504h. A solder material 504c is provided on the upper surface of each of the plurality of copper wirings 504b. Each of the plurality of copper wirings 504b is supported by the base substrate 504s.

In the first embodiment, the relay FPC 505 and the main FPC 504 as described above are prepared in advance. The positions of the copper wirings 505b of the relay FPC 505 are arranged so as to correspond to the positions of the copper wirings 504b of the main FPC 504.

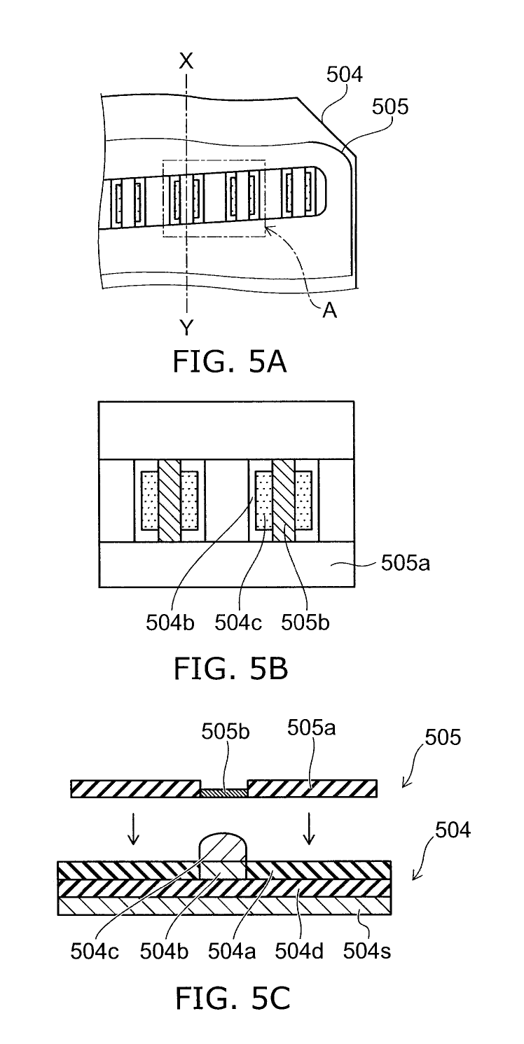

FIGS. 5A to 5C are schematic views describing the state in which the copper wirings of the relay FPC and the copper wirings of the main FPC are opposed to each other. FIG. 5A is a schematic plan view. FIG. 5B is an enlarged view of the enclosed portion indicated by the arrow A of FIG. 5A. FIG. 5C is an X-Y sectional view.

Next, the relay FPC 505 is lowered face-down from above the main FPC 504 to the main FPC 504. Thus, the plurality of copper wirings 505b in the relay FPC 505 and the plurality of copper wirings 504b in the main FPC 504 are respectively opposed to each other across the solder material 504c. The direction of the plurality of copper wirings 505b traversing the hole 505h and the direction of the plurality of copper wirings 504b traversing the hole 504h are made identical. Then, each of the plurality of copper wirings 505b is brought into contact with the solder material 504c. In order to improve the contact between all the plurality of copper wirings 505b and the solder material 504c, a load may be applied to each of the plurality of copper wirings 505b toward a side of the base substrate 504s.

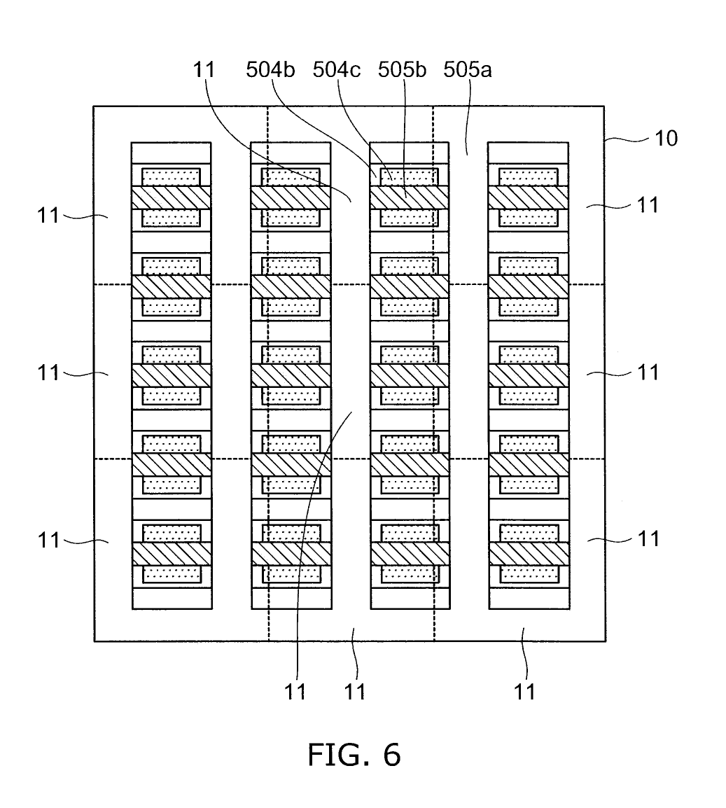

FIG. 6 is a view for describing a method for partitioning the region disposed with the plurality of second connection terminals into a plurality of rectangular regions.

Next, the placement region 10 disposed with the plurality of copper wirings 505b in the insulating film substrate 505a is partitioned into a plurality of rectangular regions 11. The rectangular region 11 is larger than the area occupied by each of the plurality of copper wirings 505b. For instance, the placement region 10 is partitioned vertically into three, and horizontally into three. That is, as viewed in the direction perpendicular to the major surface of the insulating film substrate 505a, the plurality of rectangular regions 11 constitute a matrix in which the same rectangular regions 11 are arranged vertically and horizontally.

The planar shape of the placement region 10 is e.g. a rectangle with one side of 6-7 mm. The number of copper wirings 505b (copper wirings 504b) is not limited to that illustrated, but may be 20-60.

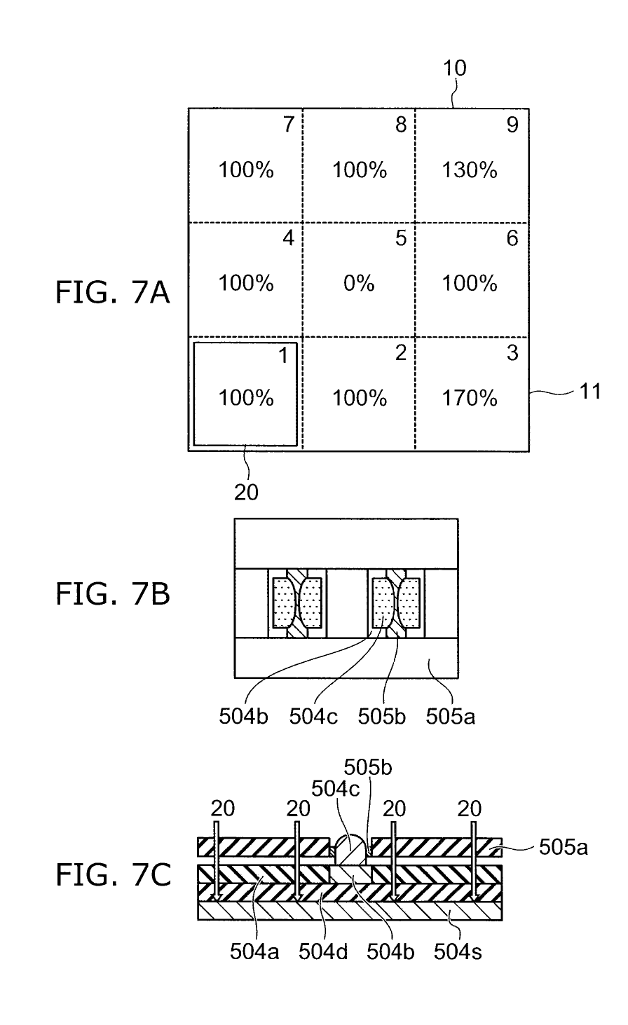

FIGS. 7A to 7C describe the sequence of soldering. FIG. 7A describes the sequence of irradiating the plurality of rectangular regions with laser light. FIG. 7B is an enlarged view corresponding to the enclosed portion indicated by the arrow A of FIG. 5A. FIG. 7C is a sectional view corresponding to the X-Y cross section of FIG. 5A. In the rectangular regions 11 of FIG. 7A, the irradiation time of laser light 20 is indicated in percentage. The percentage values of the irradiation time of laser light 20 are not limited to those indicated in FIG. 7A.

As shown in FIG. 7A, the plurality of rectangular regions 11 are sequentially irradiated with laser light 20 from a side of the insulating film substrate 505a. The laser light 20 is selected to be laser light which can be transmitted through the insulating film substrate 505a. For instance, the wavelength X of the laser light 20 is 600 nm or more (e.g., 808 nm). Here, each of the plurality of rectangular regions 11 is matched with the irradiation region of the laser light 20.

In the first embodiment, the beam diameter of the laser light 20 is shaped so that the area of each of the plurality of rectangular regions 11 and the irradiation area of the laser light 20 are generally equal. For instance, the planar shape of each of the plurality of rectangular regions 11 and the spot shape of the laser light 20 are generally equal. Furthermore, in the rectangular region 11, the light intensity of the laser light 20 is generally uniform. In the first embodiment, the rectangular region 11, which is adjacent to the rectangular region 11 irradiated previously with the laser light 20, is sequentially irradiated with the laser light 20. That is, the rectangular region 11, which is adjacent to the rectangular region 11 irradiated previously with the laser light 20, is selected as a next rectangular region 11 to be irradiated with the laser light 20.

For instance, the plurality of rectangular regions 11 are assigned with numbers “1”-“9”. In this case, first, the rectangular region 11 of number “1” (the rectangular region 11 located at a corner of the placement region 10) is irradiated. Then, irradiation with the laser light 20 is continued in the order of “2”, “3”, “6”, “9”, “8”, “7”, and “4”. The rectangular region 11 located at the center (number “5”) of the matrix-shaped placement region 10 is not irradiated with the laser light 20. The reason for this will be described later.

In the first embodiment, the cycle of sequentially irradiating a plurality of rectangular regions 11 along the outer periphery of the matrix-shaped placement region 10 with the laser light 20 is performed at least once. For instance, this cycle is defined as one routine, and this routine is performed once, or repeated 2 to hundreds of times. In irradiation with the laser light 20, a load may be applied to each of the plurality of copper wirings 505b toward the side of the base substrate 504s.

The transmittance of the insulating film substrates 505a, 504a and the adhesive 504d for the light of wavelength 808 nm may be e.g. 10-20%. The laser light 20 is transmitted through the insulating film substrates 505a, 504a and the adhesive 504d to the base substrate 504s. Thus, the base substrate 504s is irradiated with the laser light 20. This increases the temperature of the base substrate 504s (see FIG. 7C).

With the increase of the temperature of the base substrate 504s, heat is conducted from the base substrate 504s to the solder material 504c. When the temperature of the solder material 504c reaches a prescribed temperature, the solder material 504c is melted. In the case of applying a load to each of the plurality of copper wirings 505b toward the side of the base substrate 504s, each of the plurality of copper wirings 505b is reliably brought into contact with the solder material 504c. In this state, if the solder material 504c is melted, each of the plurality of copper wirings 505b gets wet with the melted solder material 504c and the melted solder material 504c spreads to the upper surface of each of the plurality of copper wirings 505b. This state is shown in FIGS. 7B and 7C.

In the first embodiment, the solder material 504c is not directly irradiated with laser light having a beam diameter converged approximately to the area of the solder material 504c. In the first embodiment, the base substrate 504s is irradiated with the laser light 20 having a beam diameter wider than the area of the solder material 504c. Thus, the solder material 504c is indirectly melted by heat conduction from the base substrate 504s.

More specifically, in the first embodiment, the base substrate 504s, which is the lower substrate, is irradiated with the laser light 20 having a spot shape larger than the area occupied by the solder material 504c. Furthermore, the aforementioned routine is performed once, or repeated 2 to 300 times. Thus, the base substrate 504s is heated so that the temperature distribution in the placement region 10 is made uniform. By heat conduction from the base substrate 504s, all the solder materials 504c interposed between the plurality of copper wirings 504b and the plurality of copper wirings 505b are melted collectively and simultaneously.

When all the solder materials 504c are simultaneously melted, all the copper wirings 505b of the relay FPC 505 dig into the solder materials 504c. This digging moves the insulating film substrate 505a entirely to a side of the base substrate 504s. Thus, each of the plurality of copper wirings 505b gets wet with the melted solder material 504c and the melted solder material 504c spreads to the upper surface of each of the plurality of copper wirings 505b.

Subsequently, laser light irradiation is stopped. Thus, the solder material 504c is solidified again. Hence, the plurality of copper wirings 504b and the plurality of copper wirings 505b are respectively bonded with the solder material 504c.

In the first embodiment, the irradiation position of the laser light 20 is stopped in each of the plurality of rectangular regions 11. Each of the plurality of rectangular regions 11 is irradiated with the laser light 20 for a prescribed duration. For instance, the duration to irradiate one rectangular region 11 with the laser light 20 is approximately several milliseconds (e.g., 5-10 milliseconds). The duration for the laser light 20 to move between the adjacent rectangular regions 11 is one millisecond or less (e.g., 0.5 milliseconds).

In the first embodiment, among the plurality of rectangular regions 11, the rectangular region 11 having a relatively larger heat loss is irradiated longer with the laser light 20. For instance, assuming that the rectangular region 11 of number “3” and the rectangular region 11 of number “9” have a larger heat loss than the other rectangular regions 11, the duration to irradiate the rectangular regions 11 may be controlled as below. Specifically, the neighborhood of the rectangular region 11 of number “3” and the neighborhood of the rectangular region 11 of number “9” may be firmly fixed with screws to the head section 502. In this case, heat easily escapes from the rectangular region 11 of number “3” and the rectangular region 11 of number “9” to the head section 502. Furthermore, depending on the material of the screws, the screw itself may easily absorb the heat.

In such cases, the duration to irradiate the other rectangular regions 11 with the laser light 20 is set to “100%”. In contrast, the duration to irradiate the rectangular region 11 of number “3” and the rectangular region 11 of number “9” with the laser light 20 is set to “170%” and “130%”, respectively.

The irradiation time of the laser light 20 in each rectangular region 11 is suitably changed depending on the laser output power and the heat capacity of the rectangular region 11. However, the irradiation time of the laser light 20 is adjusted so as to avoid heat damage to the insulating film substrates 505a, 504a and the adhesive 504d.

In the first embodiment, the rectangular region 11 located at the center of the placement region 10 is not irradiated with the laser light 20. In the first embodiment, the outer periphery of the placement region 10 is irradiated with the laser light 20. Thus, the outer periphery of the base substrate 504s is temporarily heated. Then, the central portion of the base substrate 504s is indirectly heated by heat conduction from the outer periphery of the base substrate 504s. This is based on the following reason.

For instance, the base substrate 504s may be fixed to the head section 502 by screwing and the like. In this case, depending on the specification of the screwing and the like, heat in the portion nearer to the outer periphery of the placement region 10 may escape more easily to the outside of the base substrate 504s. In such a situation, if all the rectangular regions 11 are irradiated with laser light of the same power for the same duration, the outer periphery of the placement region 10 may fail to be sufficiently heated. Thus, at the outer periphery of the placement region 10, soldering failure may occur. Conversely, if the irradiation with laser light is continued so as to melt the solder material 504c at the outer periphery of the placement region 10, then the central portion of the base substrate 504s is excessively heated.

Thus, in the first embodiment, the outer periphery of the placement region 10 is preferentially irradiated with the laser light 20 to control so that the in-plane temperature of the base substrate 504s is made uniform. Hence, all the solder materials 504c of the placement region 10 can be melted simultaneously and uniformly.

Thus, in the first embodiment, the amount of energy input to each rectangular region 11 can be changed by selecting the rectangular region 11 to be irradiated with the laser light 20, and by suitably changing the irradiation time. Hence, the temperature distribution of the heated base substrate 504s is made uniform even if a spatial difference in heat capacity occurs in the connection terminals or in the base substrate.

In the soldering method as described above, all the copper wirings 504b and all the copper wirings 505b, respectively, shown in FIG. 6 are uniformly bonded with the solder material 504c. According to the first embodiment, the soldering connection reliability between the connection terminals is ensured.

Furthermore, in the first embodiment, the size change of the placement region 10 only requires suitable change of the irradiation region of the laser light 20. Hence, the size change of the placement region 10 requires no design change of the optical system described later.

As a comparative example for the first embodiment, there is a method of simply spreading the beam diameter of laser beam. In this method, the ball grid array of a semiconductor chip is entirely irradiated with the laser beam light. Accordingly, the ball grid array is entirely melted by the collective reflow technique.

However, even if the beam diameter is simply spread, the central intensity of the laser beam is relatively increased due to the Gaussian distribution. Hence, in this method, there are problems that only the center of the ball grid array is reflowed, and the periphery of the ball grid array is not reflowed.

In this case, as an alternative method, an optical system such as a kaleidoscope can be used so that the intensity distribution of laser light is made uniform. However, the individual ball grids may be disposed in regions with different heat capacities. Hence, also in this case, some ball grids may be difficult to reflow. Furthermore, if the size of the region disposed with ball grids differs for each device, the design change of the optical system is needed for each device.

In the first embodiment, the insulating film substrates 505a, 504a, the adhesive 504d, and the copper wirings 504b, 505b formed into thin wires are irradiated with laser light. The base substrate 504s is fixed with e.g. screws to the head section 502. In the portion where the base substrate 504s is in firm contact with the head section 502 by e.g. screws, heat easily escapes from the base substrate 504s to the head section 502. Thus, if the aforementioned comparative example is adopted, it may be difficult to solder some of the connection terminals disposed on the base substrate 504s.

As an alternative comparative example, there is a method of directly irradiating the connection terminals with laser light to melt the solder material. In this method, the connection terminal disposed in a region with high heat capacity can be irradiated with laser light by increasing the irradiation time or power of the laser light.

However, if reflow is performed individually for each connection terminal, the individual solder material is individually melted. Hence, if this method is applied to this embodiment, there are problems that the overall upper substrate fails to move to the side of the lower substrate during the reflow. Thus, some connection terminals incur connection deficiency. Furthermore, as described above, the intensity of laser light is higher toward the center. Thus, the insulating film substrates 505a, 504a and the adhesive 504d may be subjected to heat damage. Moreover, in the case where the copper wirings 504b, 505b are miniaturized into thin wires, the copper wirings 504b, 505b themselves are also subjected to heat damage.

### Second Embodiment

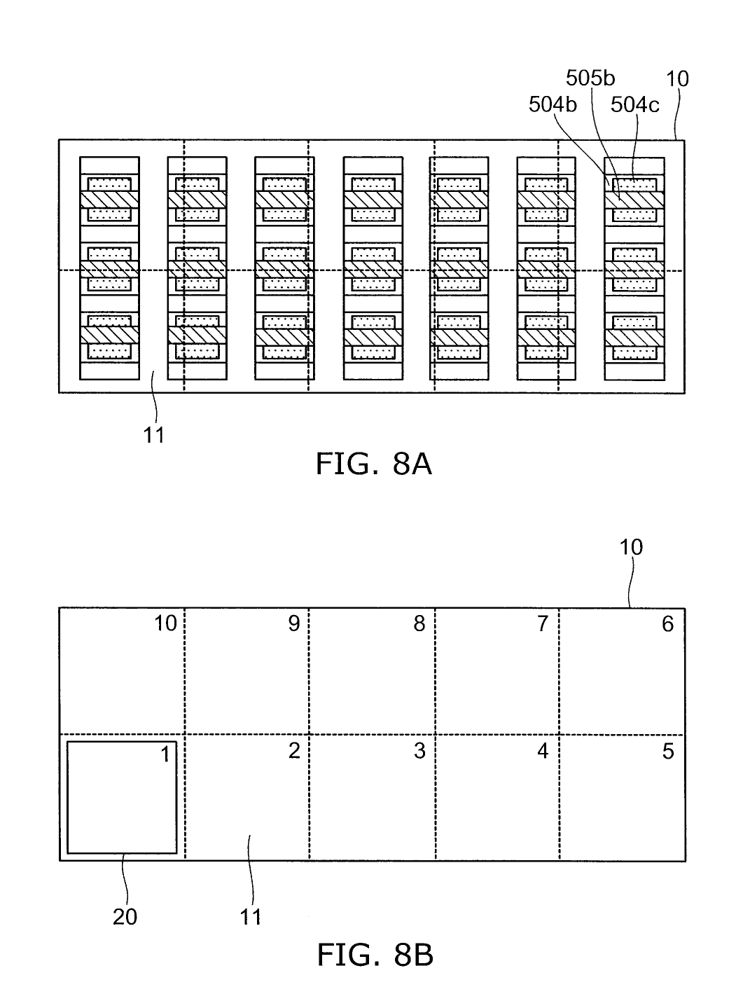

FIGS. 8A and 8B describe the sequence of soldering according to a second embodiment. FIG. 8A is a view for describing a method for partitioning the region disposed with the plurality of second connection terminals into a plurality of rectangular regions. FIG. 8B describes the sequence of irradiating the plurality of rectangular regions with laser light.

The cycle of moving the laser light 20 in the placement region 10 is not limited to the cycle of the first embodiment.

For instance, as shown in FIG. 8A, the arrangement and number of the plurality of copper wirings 505b (or the plurality of copper wirings 504b) may be different from those of the first embodiment. Then, partitioning of the placement region 10 is suitably changed. For instance, in the second embodiment, the placement region 10 is partitioned vertically into two, and horizontally into five. Furthermore, as shown in FIG. 8B, the plurality of rectangular regions 11 are assigned with numbers “1”-“10”.

In the second embodiment, first, the rectangular region 11 of number “1” located at a corner of the placement region 10 is irradiated. Then, irradiation with the laser light 20 is continued in the order of “2”, “3”, “4”, “5”, “6”, “7”, “8”, “9”, and “10”. After that, subsequently, the rectangular region 11 of number “1” and the rectangular region 11 of number “5” are again irradiated with the laser light 20 for a prescribed duration. In the second embodiment, the cycle including this reirradiation is defined as one routine.

The second embodiment assumes the case where heat loss is relatively large in the lower left and lower right rectangular regions 11 (i.e. number “1” and number “5” in FIG. 8B) of the placement region 10. In such a case, in the second embodiment, irradiation of the lower left and lower right rectangular regions 11 of the placement region 10 with the laser light 20 is not limited to once in one routine, but they are irradiated a plurality of times. Also by such a method, the temperature of the heated base substrate 504s is made uniform.

In the first embodiment, among the plurality of rectangular regions 11, the rectangular region 11 having a relatively larger heat loss is irradiated longer with the laser light 20. In the second embodiment, after one lap of the laser irradiation on the placement region 10, among the plurality of rectangular regions 11, the rectangular region 11 having a relatively large heat loss is irradiated again.

Also by such a method, the amount of energy input to each rectangular region 11 can be changed. Hence, the temperature distribution of the heated base substrate 504s is made uniform even if a spatial difference in heat capacity occurs in the connection terminals and the base substrate. Thus, like the first embodiment, the soldering connection reliability between the connection terminals is ensured.

### Third Embodiment

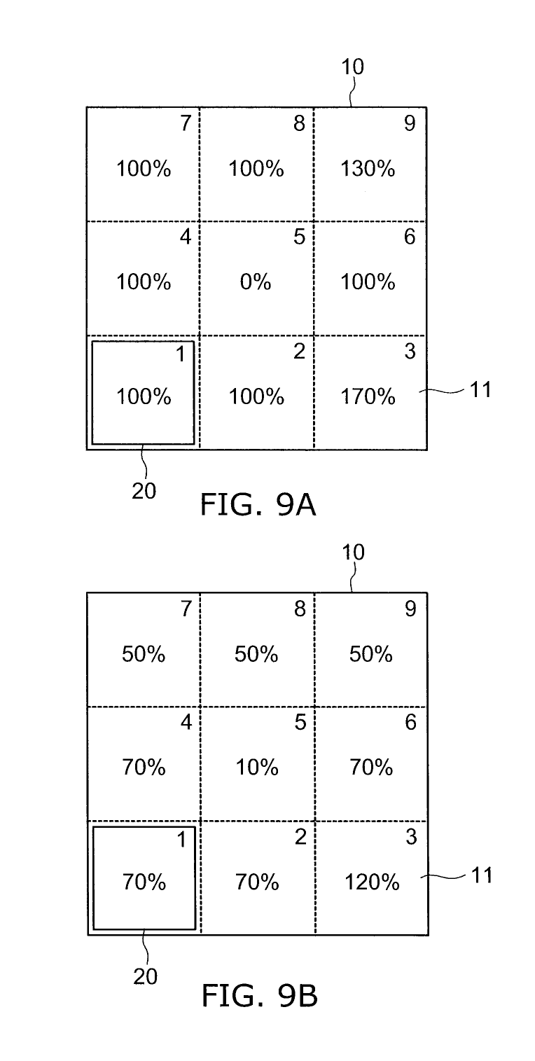

FIGS. 9A and 9B describe the sequence of soldering according to a third embodiment. FIGS. 9A and 9B show the sequence of irradiating the plurality of rectangular regions with laser light. In the rectangular regions 11 of FIGS. 9A and 9B, examples of the irradiation time of laser light 20 are indicated in percentage. The percentage values of the irradiation time of laser light 20 are not limited to those indicated in FIGS. 9A and 9B.

In the third embodiment, within the duration for all the solder materials 504c to be melted by irradiation with the laser light 20, the condition for irradiating each of the plurality of rectangular regions 11 with the laser light 20 is changed. For instance, the duration to irradiate each of the plurality of rectangular regions 11 with the laser light 20 is changed.

Specifically, it is assumed that it takes 1.0 second for all the solder materials 504c to be melted by irradiation with the laser light 20. In the third embodiment, the irradiation with the laser light 20 is performed in 0.0-0.5 seconds under the condition shown in FIG. 9A. The irradiation with the laser light 20 is performed in 0.5-1.0 second under the condition shown in FIG. 9B.

Here, the condition shown in FIG. 9A is the same as the condition shown in FIG. 7A.

Next, in 0.5-1.0 second shown in FIG. 9B, first, the rectangular region 11 of number “1” is irradiated. Then, irradiation with the laser light 20 is continued in the order of “2”, “3”, “6”, “9”, “8”, “7”, “4”, and “5”. In FIG. 9B, the rectangular region 11 located at the center (number “5”) of the placement region 10 is also irradiated with the laser light 20. In the rectangular regions 11 of numbers “1”, “2”, “6”, and “4”, the duration for irradiation with the laser light 20 is set to “70%”. In the rectangular region 11 of number “3”, the duration for irradiation with the laser light 20 is set to “120%”. In the rectangular regions 11 of numbers “7”, “8”, and “9”, the duration for irradiation with the laser light 20 is set to “50%”. In the rectangular region 11 of number “5”, the duration for irradiation with the laser light 20 is set to “10%”. Condition switch from FIG. 9A to FIG. 9B is performed continuously.

The third embodiment can avoid possible results produced by the irradiation condition of FIG. 9A (e.g., the possibility of monotonic increase of the local surface temperature of the solder material 504c and the temperature of the base substrate 504s by irradiating a plurality of rectangular regions 11 along the outer periphery of the placement region 10 with the laser light 20).

Thus, damage to the base substrate 504s, the adhesive 504d, the insulating film substrate 504a, the copper wirings 504b, the insulating film substrate 505a, and the copper wirings 505b is avoided. This ensures good wetting and spreading of the solder material 504c.

### Fourth Embodiment

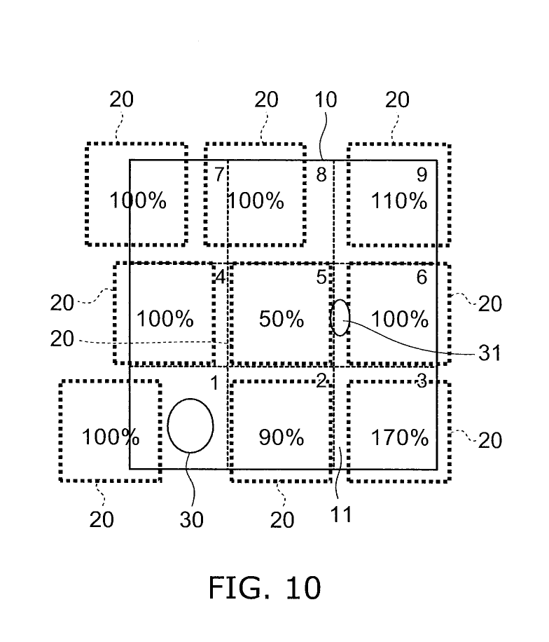

FIG. 10 describes the sequence of soldering according to a fourth embodiment. FIG. 10 shows the sequence of irradiating the plurality of rectangular regions with laser light. In the rectangular regions 11 of FIG. 10, an example of the irradiation time of laser light 20 is indicated in percentage. The percentage values of the irradiation time of laser light 20 may be the same as those in FIG. 7A (or FIG. 9A), and are not limited to those indicated in FIG. 10.

In the fourth embodiment, the irradiation region of the laser light 20 may be not matched with some of the plurality of rectangular regions 11. Instead, the irradiation region of the laser light 20 may be displaced from some of the plurality of rectangular regions 11. Alternatively, the irradiation area of the laser light 20 may be changed for some of the plurality of rectangular regions 11.

For instance, the placement region 10 may include places 30, 31 which are relatively likely to be overheated. In this case, these places 30, 31 are avoided in irradiation with the laser light 20. That is, in the fourth embodiment, the irradiation region of the laser light 20 is displaced from some of the plurality of rectangular regions 11. Alternatively, the irradiation area of the laser light 20 is changed for some of rectangular regions 11. Thus, the places 30, 31 are avoided in irradiation with the laser light 20.

For instance, a portion of the rectangular region 11 of number “1” (e.g., place 30) may not be screwed to the head section 502. From this portion, heat may be less likely to escape to the head section 502.

Furthermore, the rectangular region 11, which is adjacent to the rectangular region 11 irradiated previously with the laser light 20, can be selected as the next rectangular region 11 to be irradiated with the laser light 20. In this case, the following possibility also exists. For instance, in the case where the adjacent rectangular regions 11 are irradiated with the laser light 20, the neighborhood (e.g., place 31) of the boundary between the adjacent rectangular regions 11 is laser heated effectively twice. Hence, the neighborhood of the boundary between the adjacent rectangular regions 11 may be likely to be locally overheated.

Specifically, in the rectangular region 11 of number “1”, the irradiation region of the laser light 20 is displaced from this rectangular region 11. Thus, the place 30 is avoided in irradiation with the laser light 20. In the rectangular region 11 of number “6”, the irradiation area of the laser light 20 is made smaller than the rectangular region 11. Thus, the place 31 is avoided in irradiation with the laser light 20.

According to the fourth embodiment, the adverse effect of directly irradiating the places 30, 31 with the laser light 20 (e.g., damage to the base substrate 504s, the adhesive 504d, the insulating film substrate 504a, the copper wirings 504b, the insulating film substrate 505a, and the copper wirings 505b in and near the places 30, 31) is avoided. This ensures good wetting and spreading of the solder material 504c.

### Fifth Embodiment

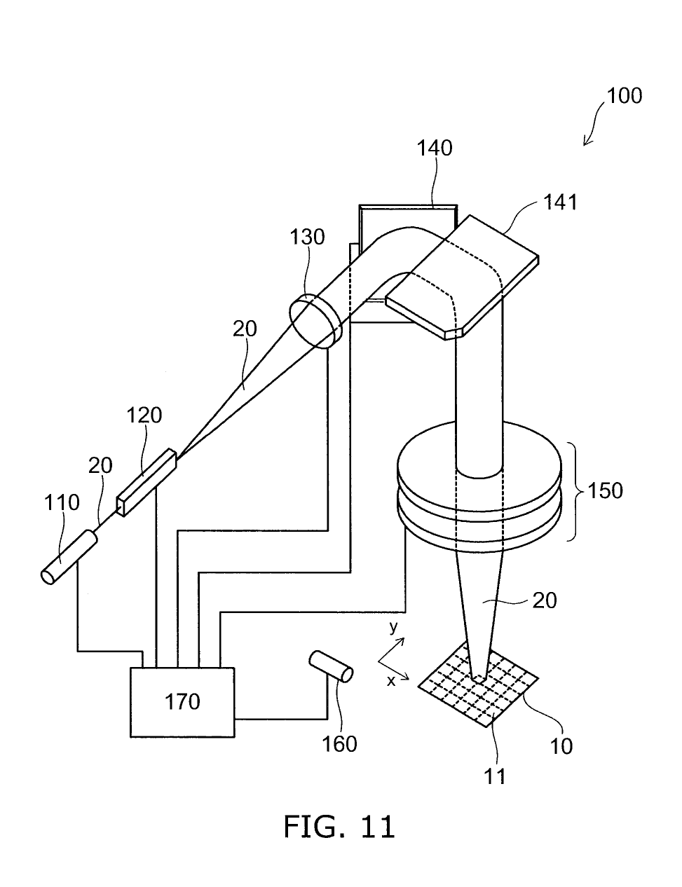

FIG. 11 describes a soldering apparatus according to a fifth embodiment. FIG. 11 shows a model of the soldering apparatus 100.

The soldering apparatus 100 shown in FIG. 11 includes a laser source 110, a kaleidoscope 120, a collimating lens 130, beam scanning mirrors 140, 141, a converging lens 150, a camera 160, and a controller 170.

The soldering apparatus 100 opposes a lower substrate and an upper substrate to each other. On the lower substrate, a plurality of first connection terminals are disposed. A solder material 504c is provided on the upper surface of each of the plurality of first connection terminals. On the upper substrate, a plurality of second connection terminals are disposed so as to correspond to the respective positions of the plurality of first connection terminals. Then, the soldering apparatus 100 bonds the plurality of first connection terminals and the plurality of second connection terminals respectively with the solder material. The first connection terminal is e.g. a copper wiring 504b. The lower substrate is e.g. a base substrate 504s. The second connection terminal is e.g. a copper wiring 505b. The upper substrate is e.g. an insulating film substrate 505a.

Laser light 20 emitted from the laser source 110 is guided to the kaleidoscope 120. At the emission end of the kaleidoscope 120, the in-plane intensity distribution in the cross section of the laser light 20 is made uniform. Furthermore, the spot shape of the laser light 20 is made generally similar to the planar shape of the rectangular region 11. The laser light 20 having passed through the kaleidoscope 120 is guided to the collimating lens 130.

The parallel laser light 20 having passed through the collimating lens 130 is guided to the beam scanning mirrors 140, 141. The laser light 20 reflected from the beam scanning mirror 141 is guided to the converging lens 150. The laser light 20 is converged by the converging lens 150. Finally, the laser light 20 is imaged on the placement region 10. The spot shape of the laser light 20 irradiating the placement region 10 is generally the same as the shape of the rectangular region 11 as described above (see FIG. 7A). The placement region 10, the rectangular region 11, and the spot shape of the laser light 20 are monitored by the camera 160.

The operation of the laser source 110, the kaleidoscope 120, the collimating lens 130, the beam scanning mirrors 140, 141, the converging lens 150, and the camera 160 is controlled by the controller 170.

In the soldering apparatus 100, the beam scanning mirrors 140, 141 are provided midway through the optical path. By operating the beam scanning mirrors 140, 141, the laser light 20 imaged on the placement region 10 can be scanned in the X direction or Y direction in the placement region 10.

The controller 170 can partition the placement region 10 disposed with the plurality of second connection terminals in the upper substrate into a plurality of rectangular regions 11. The rectangular region 11 is larger than the area occupied by each of the plurality of second connection terminals. That is, the soldering apparatus 100 includes a partitioning means for partitioning the placement region 10 disposed with the plurality of second connection terminals in the upper substrate into a plurality of rectangular regions 11. The rectangular region 11 is larger than the area occupied by each of the plurality of second connection terminals.

The controller 170 operates the beam scanning mirrors 140, 141. Thus, the controller 170 can sequentially irradiate the plurality of rectangular regions 11 with the laser light 20 from the side of the upper substrate. The laser light 20 can be transmitted through the upper substrate. Thus, the temperature of the lower substrate is increased. Hence, heat is conducted from the lower substrate to the solder material. Thus, the solder material 504c can be melted. That is, the soldering apparatus 100 includes a irradiating means. The irradiating means sequentially irradiates the plurality of rectangular regions 11 with the laser light 20 from the side of the upper substrate. Thus, the temperature of the lower substrate is increased. Hence, heat is conducted from the lower substrate to the solder material. Thus, the solder material 504c is melted.

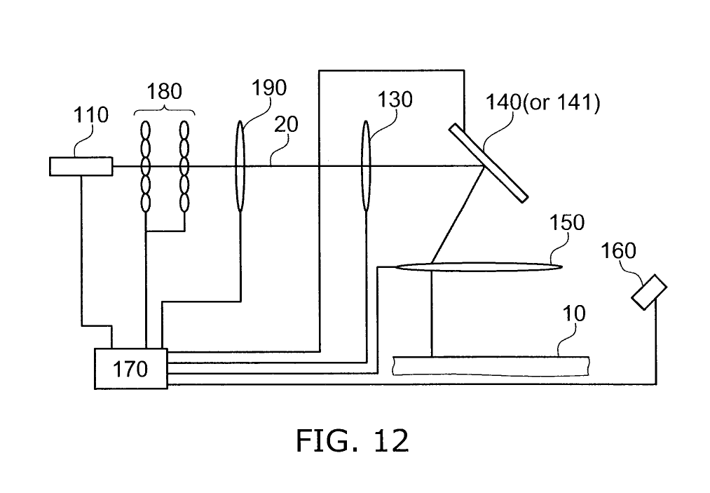

FIG. 12 describes a variation of the soldering apparatus according to the fifth embodiment.

Besides the kaleidoscope 120, a fly-eye lens 180 may be used to perform the shaping of the spot shape of the laser light 20. For instance, laser light 20 emitted from the laser source 110 is guided to the fly-eye lens 180.

At the emission end of the fly-eye lens 180, the in-plane intensity distribution in the cross section of the laser light 20 is made uniform. Furthermore, the spot shape of the laser light 20 is made generally similar to the planar shape of the rectangular region 11. Then, the laser light 20 is converged by a condenser lens 190 and guided to the collimating lens 130. The subsequent optical path of the laser light 20 is the same as that of FIG. 11.

The embodiments have been described above with reference to examples. However, the embodiments are not limited to these examples. More specifically, these examples can be suitably modified in design by those skilled in the art. Such modifications are also encompassed within the scope of the embodiments as long as they include the features of the embodiments. The components included in the above examples and their layout, material, condition, shape, size and the like are not limited to those illustrated, but can be suitably modified. For instance, the laser light may be replaced by lamp light. The object to be soldered is not limited to connection terminals in a hard disk. The embodiments are also applicable to connection terminals provided in such devices as a semiconductor device, flat panel display, and solar cell.

Furthermore, the components included in the above embodiments can be combined as long as technically feasible. Such combinations are also encompassed within the scope of the embodiments as long as they include the features of the embodiments. In addition, those skilled in the art can conceive various modifications and variations within the spirit of the embodiments. It is understood that such modifications and variations are also encompassed within the scope of the embodiments.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A soldering method comprising:
preparing a lower substrate supporting a plurality of first connection terminals with a solder material provided on an upper surface of each of the plurality of first connection terminals, and an upper substrate with a plurality of second connection terminals corresponding to respective positions of the plurality of first connection terminals, and the plurality of second connection terminals disposed on the upper substrate;
opposing the plurality of first connection terminals and the plurality of second connection terminals respectively to each other across the solder material;
partitioning a placement region disposed with the plurality of second connection terminals in the upper substrate into rectangular regions, each of the rectangular regions being larger than area occupied by each of the plurality of second connection terminals;
irradiating each of the rectangular regions sequentially with light from a side of the upper substrate to melt the solder material provided on the lower substrate by increasing temperature of the lower substrate, and the light capable of being transmitted through the upper substrate; and
bonding the plurality of first connection terminals and the plurality of second connection terminals respectively with the solder material.

2. The method according to claim 1, wherein as viewed in a direction perpendicular to a major surface of the upper substrate, the plurality of rectangular regions constitute a matrix with the rectangular regions arranged vertically and horizontally, and one of the rectangular regions adjacent to another one of the rectangular regions is selected as a next rectangular region to be irradiated with the light after irradiating the another one of the rectangular regions with the light.

3. The method according to claim 1, wherein each of the plurality of rectangular regions is irradiated with the light for a prescribed duration.

4. The method according to claim 1, wherein a load is applied to each of the plurality of second connection terminals toward a side of the lower substrate in irradiation with the light.

5. The method according to claim 1, wherein area of each of the plurality of rectangular regions and irradiation area of the light are generally equal.

6. The method according to claim 1, wherein as viewed in a direction perpendicular to a major surface of the upper substrate, irradiation area of the light is larger than area occupied by the solder material.

7. The method according to claim 1, wherein light intensity of the light is generally uniform in an irradiation region of the light.

8. The method according to claim 1, wherein each of the plurality of rectangular regions is matched with an irradiation region of the light.

9. The method according to claim 1, wherein the solder material interposed between the plurality of first connection terminals and the plurality of second connection terminals is collectively melted by heat conduction from the lower substrate.

10. The method according to claim 1, wherein, among the plurality of rectangular regions, a rectangular region having a relatively larger heat loss is irradiated longer with the light.

11. The method according to claim 2, wherein, among the plurality of rectangular regions, each of the rectangular regions along an outer periphery of the matrix are sequentially irradiated with the light.

12. The method according to claim 11, wherein, among the plurality of rectangular regions, a rectangular region having a relatively large heat loss is irradiated again with the light after the each of the rectangular regions along the outer periphery of the matrix are sequentially irradiated with the light.

13. The method according to claim 1, wherein the light has a wavelength of 600 nm or more.

14. The method according to claim 1, wherein
a first insulating substrate is provided on the lower substrate, and
the first insulating substrate includes a plurality of first holes, and each of the plurality of second connection terminals is disposed so as to traverse one of the plurality of first holes.

15. The method according to claim 1, wherein the upper substrate includes a second insulating substrate, the second insulating substrate includes a plurality of second holes, and each of the plurality of second connection terminals is disposed so as to traverse one of the plurality of second holes.

16. The method according to claim 1, wherein
a first insulating substrate is provided on the lower substrate,
the first insulating substrate includes a plurality of first holes, and each of the plurality of second connection terminals is disposed so as to traverse one of the plurality of first holes,
the upper substrate includes a second insulating substrate, the second insulating substrate includes a plurality of second holes, and each of the plurality of second connection terminals is disposed so as to traverse one of the plurality of second holes, and
direction of the plurality of second connection terminals traversing the plurality of first holes and direction of the plurality of second connection terminals traversing the plurality of second holes are identical.

17. The method according to claim 1, wherein duration of irradiation with the light is changed for each of the plurality of rectangular regions.

18. The method according to claim 1, wherein an irradiation region of the light is not matched with each of the plurality of rectangular regions.

19. The method according to claim 1, wherein irradiation area of the light is changed for each of the rectangular regions.

20. A soldering apparatus for opposing a lower substrate to an upper substrate,
the lower substrate with a plurality of first connection terminals disposed on the lower substrate, with a solder material provided on an upper surface of each of the plurality of first connection terminals,
the upper substrate with a plurality of second connection terminals disposed on the upper substrate so as to correspond to respective positions of the plurality of first connection terminals, and
bonding the plurality of first connection terminals and the plurality of second connection terminals respectively with the solder material,
the soldering apparatus comprising:
a partitioning device configured to partition a placement region disposed with the plurality of second connection terminals in the upper substrate into rectangular regions, each of the rectangular regions being larger than area occupied by each of the plurality of second connection terminals; and
an irradiating device configured to irradiate each of the rectangular regions sequentially with light from a side of the upper substrate to melt the solder material provided on the lower substrate by increasing temperature of the lower substrate, and the light capable of being transmitted through the upper substrate.
